(19) United States
(12) Patent Application Publication
(10) Pub. No.: US 2004/0247422 A1
(43) Pub. Date: Dec. 9, 2004

(54) Cargo roller system for cargo handling

(76) Inventors: Kenneth M. Neumann, St. Louis, MO (US); Anothony L. Kozich, St. Louis, MO (US)

Correspondence Address: LEWIS, RICE & FINGERSH, LC, ATTN: BOX IP DEPT., 500 NORTH BROADWAY, SUITE 2000, ST LOUIS, MO, 63102, US

(21) Appl. No.: 10/819,483

(22) Filed: Apr. 7, 2004

Related U.S. Application Data
(63) Continuation-in-part of application No. 10/462,382, filed on Jun. 16, 2003.
(60) Provisional application No. 60/460,960, filed on Apr. 7, 2003.
(60) Provisional application No. 60/389,272, filed on Jun. 15, 2002.

(51) Int. Cl. B65G 13/00

(52) U.S. Cl. 414/529; 193/35 R

(57) ABSTRACT

A roller unit that can be used to retrofit a cargo carrying surface makes loading and unloading of the cargo carrying surface easier by transforming the cargo carrying surface to include a conveyor system. The roller unit includes at least two trays in which are mounted rollers, the trays being connected by a crosspiece. The roller unit is designed to be installed on cargo carrying surfaces such as portable platforms, including Flatracks or CROPs, and in cargo containers of any type.

### CROSS REFERENCE TO RELATED APPLICATIONS

This application claims the benefit of U.S. Provisional Application No. 60/460,960, filed Apr. 7, 2003, and is a Continuation-in-Part of U.S. Utility patent application Ser. No. 10/462,382, filed on Jun. 16, 2003, which claims the benefit of U.S. Provisional Application No. 60/389,272, filed Jun. 15, 2002, the entire disclosures of which are herein incorporated by reference.

### STATEMENT REGARDING FEDERALLY SPONSORED RESEARCH OR DEVELOPMENT

Not Applicable.

### BACKGROUND OF THE INVENTION

1. Field of Invention

The invention generally provides systems and methods for loading cargo into containers and onto platforms using rollers. More particularly, the invention provides a framework having rollers which framework may be placed in cargo containers or on platforms to retrofit such equipment with roller systems for aiding in the loading of such equipment.

2. Description of Related Art

Militaries around the world use a wide variety of different transport vehicles for getting materials that are needed for effective combat operations from the plants or factories where those materials are manufactured or stored for deployment to the point where those materials are needed to carry out particular operations. Because of the nature of military operations, materials to be transported range widely, including mundane items such as toiletries and specialized items such as ammunition. The variation in weight, shape, size, and other characteristics of the materials needed to be transported leads to numerous logistical problems in getting materials from the point of manufacture to the soldier in the field. Often, materials need to be transported by aircraft to reach a distant theater, but usually transport aircraft cannot land at the forward edge of the battle area or other similar points where the materials are most needed. Instead, specialty trucks usually move the materials from an airfield to a supply point from which they can be further distributed to combat forces.

Traditionally, the transport of materials in military aircraft has used specially constructed pallets generally referred to as 463L pallets (United States Air Force part numbers 7031843 (HCU-6E) and 7133047 (HCU-12E)). These pallets are of standard size, shape, and construction so that loading and securing of the pallet in the aircraft is facilitated through standardized locking rail systems which interact with structures built into the pallet for that purpose. These pallets are also specifically designed to be very strong for their weight. Other pallets (referred herein as “platforms”) used by transport trucks, on the other hand, are generally larger and more rugged because trucks are not as dependent on weight limits as aircraft. In particular, the transport of platforms is generally performed by trucks with Pallet Load/unload Systems (PLS/LHS trucks). These trucks generally use platforms or skids such as those referred to as “Flatracks” or “Container Ready On/off Platforms” (CROPs). Embodiments of these platforms are shown in U.S. Pat. Nos. 4,911,318 and 5,799,585, the entire disclosures of which are herein incorporated by reference. These platforms are loaded onto and off of trucks using an overhead hook system which pulls the platform onto the back of the truck.

Because trucks and aircraft generally use different pallets, in order to transfer materials from the aircraft to the truck (or vice-versa) it has been necessary to remove the 463L pallet from the aircraft (often using what is commonly referred to as a K-loader), remove the 463L pallet from the K-loader, unpack the materials from the 463L pallet, repack the materials on a platform, such as a Flatrack or CROP, and then load the platform on a truck for transport to the supply point. This series of steps is inefficient, requires significant man-hours of labor, and is a hindrance to getting materials to the supply point as quickly as possible.

### SUMMARY

While it may at first appear that a 463L pallet could be loaded directly onto a platform, such a process has a significant problem because 463L pallets have flat bottoms and typical platforms have generally flat tops. Therefore, such a loading and unloading procedure results in high friction between the 463L pallet and the platform. This in turn results in slow and awkward handling and damage to both platform and pallet during loading and unloading. Note that the term “platform” is used generally and may refer to any type of platform, pallet or skid, while “pallet” is generally used to refer to any platform, pallet, or skid, that may be loaded on top of a roller unit of the present invention when the roller unit is mounted on a platform or in a cargo container.

For the reasons above discussed and other reasons known to those of ordinary skill in the art, described herein are roller units designed to be installed on cargo carrying surfaces, such as portable platforms, including Flatracks or CROPs, and cargo containers of any type, including refrigerated containers, specialty containers, over the road truck trailers, box van storage compartments, railcars, aircraft, watercraft, or any other container or transported storage area having a relatively planar cargo-supporting surface. By so installing the roller units on such cargo carrying surfaces, the surfaces are transformed to include conveyor systems, particularly making loading and unloading of those surfaces easier. In an embodiment, the roller units herein described are specially designed to interact with and engage 463L pallets or other pallets, but especially those pallets such as the 463L pallets that have flat bottom surfaces.

Where the roller unit herein described has been installed on a portable platform, such platform can then be more easily loaded with one or more flat-bottomed pallets as compared to the relative difficulty of loading flat-bottomed pallets on portable platforms not having roller units since the frictional forces are dramatically reduced by the presence of the roller unit. The entire combination of platform with loaded pallets can then be transported by a method such as is typically used for transporting such portable platforms (e.g., loading onto a truck utilizing a hook system, e.g., an LHS truck, such as those used to load traditional CROPs or Flatracks). Where the roller unit herein described has been installed in a cargo container, such a cargo container can be more easily loaded with flat-bottomed pallets, and then can still be transported as is typically done for such a cargo container.

Still further, while the embodiment described in detail herein is designed to carry 463L pallets or pallets of similar design, one would understand that a roller unit configured to interact with a 463L pallet in substantially the same way as does the locking system of an aircraft could be used in conjunction with any pallet configured to interact with the same or similar locking system whether known now or later developed. Additionally, the roller unit can be designed to interact with other standardized pallets or pallet systems that are not specifically designed to interact with the same aircraft loading and locking systems used for 463L pallets, so as to hold these other pallets and pallet systems in place on a platform or in a cargo container on which a roller unit as described herein has been installed.

In an embodiment the roller unit comprises at least two trays for mounting rollers, at least one roller for supporting cargo mounted in each of these trays, and at least one crosspiece that rigidly connects the trays. The roller unit is designed to retrofit a cargo carrying surface with a conveyor system. In an alternate embodiment, the roller unit may also include a pallet stop, which may help prevent a pallet from rolling once loaded onto the roller unit. A pallet stop may be reversibly positioned into and out of a first position, wherein it is configured to obstruct movement of cargo loaded on the roller unit. In another alternate embodiment, a roller unit may further comprise a guide rail for providing at least one of horizontal and vertical restraint to the motion of a pallet loaded onto the roller unit. Such guide rail may be adjustable in at least one of a horizontal and vertical direction compared with a plane tangent to the rollers.

Further alternate embodiments include those described in the following paragraphs. In a roller unit the rollers may be cylindrical or spherical or another shape, and may be made of any practical material, including aluminum, other metals, alloys, and plastics of various kinds. A roller unit may be designed to be reversibly attached to said cargo carrying surface. A roller unit may have a crosspiece that connects the trays so as to hold the trays in a generally parallel configuration. A roller unit may have the trays positioned so as to allow the tines of a fork truck access to a space between the cargo and the cargo carrying surface on which the roller unit is mounted.

In specific applications a roller unit may be attached to a cargo carrying surface that is the floor of an ISO cargo container or that is the top of a portable platform, including a Flatrack and a CROP. In these cases the roller unit may be designed such that the combination of the roller unit attached to the ISO cargo container or the portable platform is generally capable of carrying the maximum load for which the cargo carrying surface was rated prior to being retrofitted with a roller unit, and do so without damage to any of the roller unit, the ISO cargo container, the portable platform, and the combinations thereof.

In an alternate embodiment the present invention encompasses a device for moving cargo, comprising a generally planar cargo carrying surface and a roller unit attached adjacent to said cargo carrying surface. For this device, the cargo carrying surface may be one of the floor of an ISO cargo container and the top surface of a portable platform, including a Flatrack and a CROP.

An embodiment of the present invention further encompasses a method of loading cargo onto a generally flat cargo carrying surface, including the steps of attaching a roller unit adjacent to a generally flat cargo carrying surface, and loading cargo onto said roller unit attached to said generally flat cargo carrying surface. This method may be undertaken by performing the step of attaching so as to allow the roller unit to be reversibly detached and reattached to said cargo carrying surface.

### BRIEF DESCRIPTION OF THE DRAWINGS

FIG. 1 provides a perspective view of a first embodiment of a roller unit.

FIG. 2 provides a perspective view of a second embodiment of a roller unit installed inside a twenty-foot long ISO dry bulk container.

FIG. 3 provides an exploded perspective view of a third embodiment of a roller unit in combination with a portable platform.

### DESCRIPTION OF PREFERRED EMBODIMENT(S)

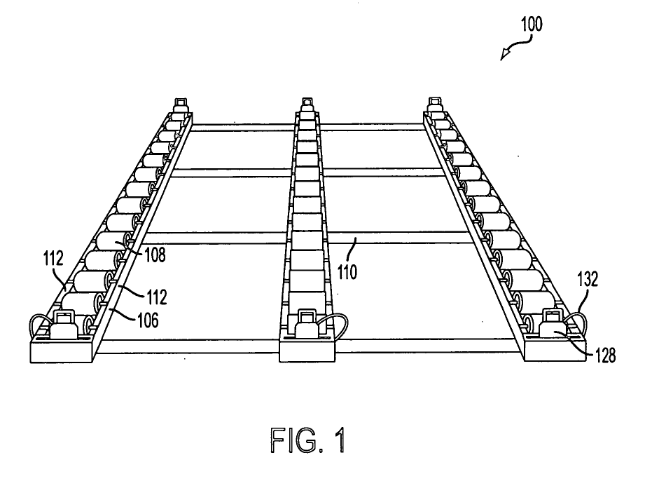

FIG. 1 depicts an embodiment of a roller unit (100) of the present invention that will be used to describe several portions of the roller unit (100) that also may be found in other embodiments. The roller unit (100) generally comprises at least one roller tray (106) in which is mounted at least one roller (108). The number of rollers (108) per tray and the number of trays (106) of rollers in any embodiment will depend upon the specific use to be made of the roller unit (100) and is a matter of engineering design. In the embodiment of FIG. 1 there are three trays (106), each tray comprising fourteen rollers (108). Here, the trays (106) are rigidly attached to one another by slats (110) that are welded between the trays (106). Generally, where a roller unit (100) is comprised of more than one tray (106), the trays (106) may be held together by any practical device, including a crosspiece of any type, such as a slat or a pipe having any practical cross section, or a plate-type, monolithic structure covering all of the area between, or between and underneath the trays (106). Any of such devices may be attached to the trays (106) by any practical method, including welding, bolting, riveting, or another method. Generally, the roller unit (100) is reversibly attachable to another assembly used to store or carry cargo, though it may also be permanently, or semi-permanently attached thereto.

Generally, a roller unit (100) will be constructed so that there exists a plane tangent to the surface of each of the rollers (108), which plane is parallel to the bottom of the tray (106) (or trays) containing the rollers (108). A roller unit (100) comprising more than one tray (106) commonly will be constructed so that the trays (106) are rigidly held parallel to one another. Neither of these common geometries is necessary, and any useful geometry is encompassed within embodiments of the present invention, including one, for instance, where a plane tangent to the rollers (108) forms an angle with the bottom of the tray(s) (106).

In FIG. 1 the rollers (108) comprise cylinders mounted perpendicularly to the length of the tray (106) on an axle running through the center axis of the roller (108). For a roller unit (100) specifically designed to be used with a 463L pallet, the rollers (108) are preferably manufactured of aluminum, which is the same material as the pallets, helping ensure the rollers do no harm to the pallets. Other materials that will not harm the 463L pallet may also be used. Generally, the rollers (108) are mounted so that an axis about which they rotate is an axis of symmetry of the roller (108). In an alternate embodiment the rollers (108) could be mounted in an alternate direction relative to the tray (106), including at an oblique angle to the length of the tray (106) or even parallel thereto. In another alternate embodiment the rollers may have a shape other than cylindrical. For example, the rollers (108) may be spheres mounted within the trays (106) on an axis that runs through the center of the sphere. In another embodiment, the rollers (108) may be spheres mounted in a manner that would allow such spheres to rotate about nearly any axis. Particularly useful may be a roller comprising a sphere able to rotate about any axis parallel to the cargo carrying surface on which the roller unit (100) is mounted. In such an embodiment cargo may be rolled onto or off of the roller unit from any direction.

In FIG. 1, a tray (106) is comprised of two parallel sides (112) to which the rollers (108) are mounted, the sides (112) generally defining a parallelpipedic box having a bottom surface adjacent to the cargo carrying surface, and a top surface that is a plane that intersects the rollers (108). The tray (106), however, need not be so constructed. In an alternate embodiment the tray (106) may be a series of rigidly connected, generally U-shaped supports aligned with the rollers (108) such that each roller (108) is mounted to one such U-shaped support. Other structures that allow a generally linear arrangement of rollers are also encompassed. Further, it is contemplated that a roller unit (100) may be constructed of an array of rollers (108) having roller positions in any pattern, or even having roller positions that are essentially random within the space occupied by the roller unit (100) in which case a tray (106) may only hold one roller (108). A significant advantage for loading and unloading is obtained, however, where the rollers (108) are arranged to provide a channel that allows the tines of a fork truck (or similar machine) access to the bottom of a pallet that is loaded onto a roller unit (100). Such access allows for easy loading and unloading of the pallet from the roller unit (100).

Also seen in FIG. 1 are pallet stops (128) that can be used to keep a pallet from rolling horizontally for any significant distance once placed on the roller unit (100), particularly during transit. In the embodiment shown, the pallet stop (128) is a flat, rectangular plate that is inserted into a vertical slot in the roller unit (100) at the end of a tray (106) so as to protrude above the plane tangent to the top of the rollers (108). The portion of the pallet stop (128) that protrudes above the plane tangent to the top of the rollers (108) provides a vertical surface against which the loaded pallet can make contact if the pallet begins to roll in the direction of the pallet stop (128). Contact between the pallet stop (128) and a moving pallet arrests the motion of the pallet, since the pallet stop (128) is held securely in place in the tray (106). Generally the roller trays (106) are designed to correlate in length with the dimensions of the pallet to be loaded thereon, such that pallet stops (128) can be placed at both ends of the length of a tray (106) in order to confine horizontal movement of a loaded pallet to a minimum. In the depicted embodiment, the pallet stops (128) are removable so that, when removed, a pallet can be loaded onto the roller unit (100) on one end and rolled to the other end of the roller unit (100) without interference. Once the pallet has been positioned properly for transport the pallet stops (128) can be put in place to maintain the pallet position relative to the two ends of the roller unit (100). Note that in FIG. 1 the stops are shown to be non-integral components of the trays (106), but are tethered thereto via a tether (132). In alternate embodiments the pallet stops (128) are made integral to the tray (106) so that they can be raised and lowered, i.e., retracted out of the way for loading, but are not designed to be removed. In further alternate embodiments, the pallet stops (128) take on other shapes and sizes, including, for example, a cylinder and a pin with multiple flat sides.

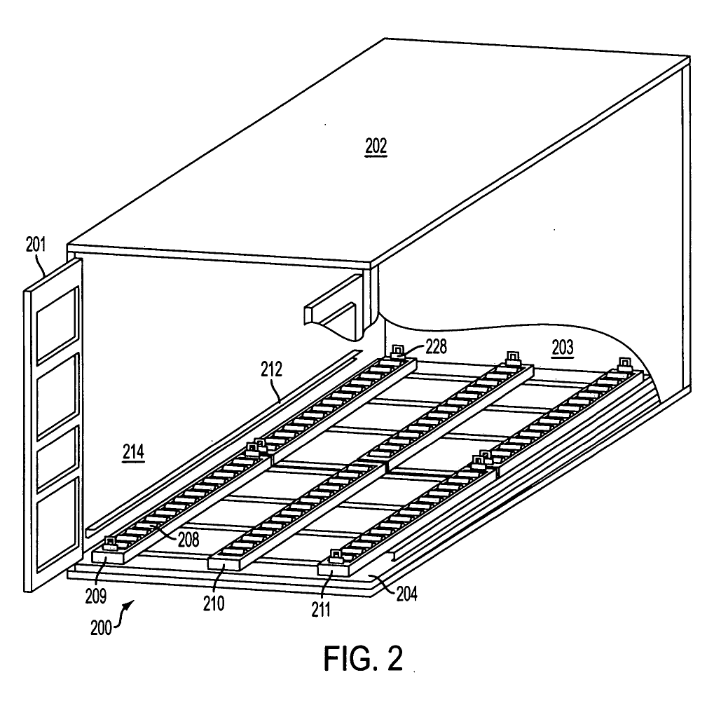

FIG. 2 shows two roller units (200) installed within an ISO cargo container (202). Such ISO cargo containers (202) are highly standardized, meeting standards set by the International Standards Organization (ISO), and are well known in the art. Due to this standardization, a roller unit (200) designed for installation in an ISO cargo container (202) can easily be removed and installed in another ISO cargo container of the same dimensions without any modification. For example, a roller unit may be designed for use generally in twenty-foot ISO cargo containers, such containers having known dimensions and being commonly used in commercial and military cargo transport. As another example, forty-foot ISO cargo containers are also common and may be the dimensional basis for a roller unit design. In FIG. 2, the roller units (200) have been attached to the wooden floor (204) of the ISO cargo container (202) using screws inserted through holes in the slats making the installation easily reversible. In an alternate embodiment other methods of attachment as are known to those of skill in the art may be used to install a roller unit (200), including installing by welding or riveting (not easily reversible) to the metal side walls (214) of the ISO cargo container (202).

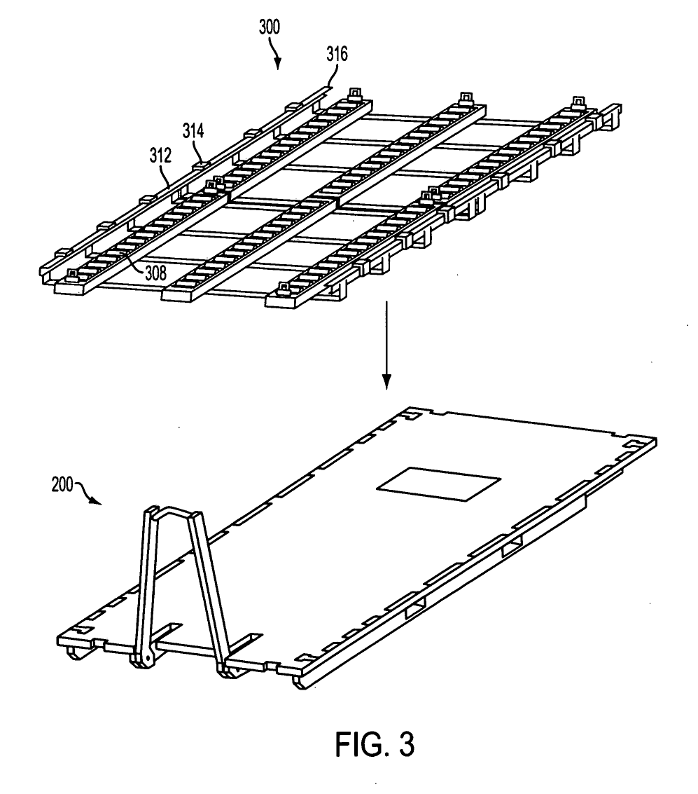

In the embodiment shown in FIG. 2, the roller units (200) operate in conjunction with separate guide rails (212) that run along the corrugated side wall (214) of the ISO cargo container (202). A particular advantage of the guide rails (212) is to provide a smooth, flat surface along which protrusions from a 463L pallet may slide during loading into and unloading from the ISO cargo container (202). Without the guide rail (212), protrusions from the 463L pallet tend to catch on the uneven, corrugated surface of the side wall (214) of the ISO cargo container (202) thereby hampering loading and unloading and possibly damaging the pallets, the cargo, or the cargo container (202), itself. In the embodiment shown the guide rails (212) are separate from the portion of the roller units (200) that include the rollers (208). In this embodiment the guide rails (212) are held in place against the side walls (214) of the ISO cargo container (202) by welding them thereto. Alternately, the guide rails (212) may be attached by any other known attachment method. In an alternate embodiment, the guide rails (212) are integral to and of a single construction with the portion of the roller unit (200) comprising the rollers (208). (See FIG. 3 for an example.)

FIG. 3 provides for another embodiment of a roller unit (300), which in this case may be installed on a cargo platform (302), such as, for example, a platform known in the art as a Flatrack or CROP. This embodiment is of similar construction and operation to the embodiment installed in an ISO cargo container (202), but is installed on a cargo platform (302) through use of ISO locks that are available on the platform (302), as opposed to being mounted with screws as discussed with respect to FIG. 2. ISO locks are well known in the art as a mechanism for securing cargo. Particularly common is the use of ISO locks on cargo platforms (302) such as such as Flatracks and CROPs, where they are used to secure other cargo carrying equipment such as ISO containers (202) and 463L pallets to the platform. Use of ISO locks allows for relatively easy installation and removal of a roller unit (300) from the platform. Utilization of the ISO locks of the cargo platform (302) for securing the roller unit (300) means that the cargo must be secured by another device, as described below.

The roller unit (300) shown in FIG. 3 incorporates interface components to accommodate loading, carriage, and off-loading particularly of 463L pallets. Specifically, this roller unit (300) includes guide rails (312) on which are mounted pallet locks (314), both of which may aid in restraining movement of a pallet loaded onto the platform (302) to which this embodiment has been mounted. Generally, these pallet interface components (guide rails and pallet locks) include mechanisms that allow the roller unit (300) to interact with a 463L pallet in a manner that is substantially similar to that of systems used in aircraft, which aircraft systems are designed for loading, unloading, and carriage of the same 463L pallet, have been in use for some time, and are well known in the art.

Several advantages may be provided by the guide rails (312) particularly in this embodiment (though they could be provided in any embodiment, including the embodiment of FIG. 2 that is mounted in an ISO cargo container (202)). One advantage of the guide rails (312) is to provide lateral support both during loading and transport. Also, as described below, the guide rails (312) may provide vertical restraint. As shown in FIG. 3, the guide rail (312) may include a horizontal extension (316) that is positioned to extend above the protrusions of a 463L pallet when said pallet is loaded onto the roller unit (300), so as to confine the pallet to the space between the plane tangent to the top of the rollers (308) and the bottom surface of the horizontal extension (316) of the guide rails (312). In this way, once a pallet is loaded onto the roller unit, it is confined to move generally parallel to the plane tangent to the rollers, so that an attempt to lift the pallet off of the platform would fail, instead lifting the platform with the pallet, since the pallet will contact the guide rails which are securely fastened to the roller unit (300), which, in turn, is securely fastened to the platform. In an alternate embodiment, the guide rails (312) may be stowed when not required either by folding or by sinking into the deck. In still another embodiment, the guide rails (312) may be adjustable laterally. In this embodiment, the guide rails can be moved to positions to accept 463L pallets in either their 88-inch biased configuration or 108-inch biased configuration. Such an embodiment can allow for even more rapid loading/unloading as the bias of the pallets can be maintained and there is no need for rotation.

Still further, the guide rail (312) provides a place to mount pallet locks (314) that also act to hold a pallet in place once loaded onto the roller unit (300). As mentioned above, preferably these pallet locks (314) operate in the same fashion as those found on current K-loaders and cargo aircraft systems now used to transport 463L pallets. Such systems are well understood by those of ordinary skill in the art. The locking mechanisms may be designed to secure the pallets in either or both the horizontal and vertical dimension. Any type of lock or locking mechanism can comprise the pallet locks (314). Those shown in FIG. 3, which are designed to depress (or extend) a portion of themselves down from the guide rails (312) to retain the pallets both horizontally and vertically by clamping them downward into the deck, are merely exemplary and are in no way intended to limit the types of pallet locks (314) which may be used. In an alternate embodiment, the pallet locks may be configured to interact with the known positioning of the aircraft interface mechanisms on the pallets, but in a completely different manner from an aircraft. For instance, the pallet locks (314) may be able to position or secure in a manner not allowed by the aircraft system or may operate in a manner completely different from the aircraft locks. The system does not require that the locking occur in any particular way (or even occur at all), the system is instead designed to allow for the roller unit (300) to interact with pallets based on the pallet's design. Specifically, the platform interacts with the portions of the pallet designed to interact with the aircraft's locking rail system. The two interactions (platform and aircraft) can occur in totally different manners or using totally different devices in an embodiment of the invention.

In addition to easing the loading by allowing rolling of the loaded 463L pallets on the rollers (308), the rollers (308) may also provide for additional functionality. In particular, rollers (308) also allow loads to be “dumped” off at the final destination. In particular, if the 463L pallets are not locked in place when the platform (302) is tilted at an angle (as generally occurs when a PLS/LHS truck loads or unloads the platform (302)), the 463L pallets can roll across the rollers (308) to separate from the platform (302). As opposed to traditional methods, there is no need to include slipsheets to have this dumping functionality. Descriptions of similar functionality of guide rails and pallet locks is described in U.S. Provisional patent application Ser. No. 10/462,382, filed Jun. 16, 2003, which is herein incorporated by reference.

As should be apparent from the above descriptions, since a roller unit (100) is designed to retrofit any of an existing ISO cargo container, CROP, or Flatrack, (but is not limited to those pieces of equipment) an embodiment of the roller unit (100) is designed so that the combination of the roller unit (100) with any of these other pieces of transport equipment can maintain the capabilities that the transport equipment had prior to the retrofit as regards the capabilities of this transport equipment to interface with other transport equipment, such as a PLS truck or fork truck. Further, in an embodiment a roller unit (100) is designed and built to allow the combination of the roller unit (100) with another piece of transport equipment, such as an ISO cargo container, CROP, or Flatrack, to maintain the same functionality as the original unmodified piece of transport equipment, while also allowing these pieces of equipment to beneficially interact with a 463L pallet or other type of pallet, which is a decided advantage to the combination. An advantage is obtained in terms of enhanced efficiency in movements of materials. Materials can be loaded onto a pallet such as the 463L pallet, which is widely used with aircraft transport such that systems and methods of air transport of 463L pallets are well known in the art. Now, since the roller unit herein described allows retrofitting of ISO cargo containers and portable platforms, the materials can remain on a 463L pallet before and after air transport for ground transport using the retrofitted equipment that is otherwise commonly used for ground transport in unmodified form, thus saving the offloading of the materials from 463L pallets and onto other platforms for ground transport. Such an advantage in transport of materials is discussed with reference to a rollerized platform in U.S. Provisional patent application Ser. No. 10/462,382, filed Jun. 16, 2003, which is herein incorporated by reference.

Use of the roller unit (200) for transporting palletized cargo is described here with reference to FIG. 2. A first pallet may be placed into the ISO cargo container (202) through the use of a forklift truck, an Air Force K loader, an external roller device, or any other object which can handle 463L pallets. The use of the three tray design, in particular, can allow forklift tines to place the pallet directly on the roller trays (209), (210), and (211) by having the tines aligned between the roller trays (209), (210), and (211). Once inside the ISO cargo container (202) the first pallet would be rolled from the door (201) toward the forward bulkhead (203) of the container (202). Pallet stops (228) would then be used to secure the first pallet in its desired position. A second pallet would then be loaded using any of the above methods into the empty space between the first pallet and the door (201) and similarly secured with pallet stops. Additional securing (such as with ropes) may be used, if desired. Removal of the pallets from the ISO cargo container (202) simply requires a reversal of the above steps.

While the invention has been disclosed in connection with certain preferred embodiments, these particular embodiments and the descriptions thereof are not limitations on the present invention. Modifications and variations of the described embodiments may be made without departing from the spirit and scope of the invention, and other embodiments should be understood to be encompassed by the present disclosure as would be understood by one of ordinary skill in the art.

1. A roller unit comprising:
at least two trays for mounting rollers;
at least one roller for supporting cargo mounted in each of said at least two trays, said rollers designed to allow translation of the cargo supported thereby via a rolling motion; and
at least one crosspiece that rigidly connects said at least two trays;
wherein said roller unit is designed to retrofit a cargo carrying surface with a conveyor system.

2. A roller unit of claim 1, wherein said at least one roller is cylindrical.

3. A roller unit of claim 2, wherein the composition of said at least one cylindrical roller comprises aluminum.

4. A roller unit of claim 1, wherein said at least one roller is spherical.

5. A roller unit of claim 5, wherein said at least one spherical roller is mounted to allow rotation about any axis generally parallel to the cargo carrying surface on which the roller unit is mounted.

6. A roller unit of claim 1, wherein said roller unit is designed to be reversibly attached to said cargo carrying surface.

7. A roller unit of claim 1, further comprising at least one pallet stop; wherein said pallet stop may be reversibly positioned into and out of a first position, and wherein when said pallet stop is in said first position, said pallet stop is configured to obstruct movement of cargo loaded on said roller unit.

8. A roller unit of claim 1, wherein said at least one crosspiece connects said at least two trays so as to hold said at least two trays in a generally parallel configuration.

9. A roller unit of claim 1, further comprising at least one guide rail for providing at least one of horizontal and vertical restraint to the motion of a pallet loaded onto said roller unit.

10. A roller unit of claim 10, wherein said guide rail is adjustable in at least one of a horizontal and vertical direction compared with a plane tangent to said at least one roller in each of said at least two trays.

11. A roller unit of claim 1, wherein the at least two trays are positioned so as to allow the tines of a fork truck access to a space between the cargo and the cargo carrying surface on which the roller unit is mounted.

12. A roller unit of claim 1, wherein the cargo carrying surface is the floor of an ISO cargo container.

13. A roller unit of claim 12, wherein said ISO cargo container is rated for carrying a maximum load prior to being retrofitted with a roller unit; and wherein the combination of said roller unit attached to said ISO cargo container is generally capable of carrying said maximum load without damage to any of said roller unit, said ISO cargo container, and said combination of said roller unit attached to said ISO cargo container.

14. A roller unit of claim 1, wherein the cargo surface is a portable platform, including a Flatrack and a CROP.

15. A roller unit of claim 14, wherein said portable platform is rated for carrying a maximum load prior to being retrofitted with a roller unit; and wherein the combination of said roller unit attached to said portable platform is generally capable of carrying said maximum load without damage to any of said roller unit, said portable platform, and said combination of said roller unit attached to said portable platform.

16. A device for moving cargo, comprising
a generally planar cargo carrying surface; and
a roller unit attached adjacent to said cargo carrying surface comprising:
at least two trays for mounting rollers;
at least one roller for supporting cargo mounted in each of said at least two trays, said rollers designed to allow translation of the cargo supported thereby via a rolling motion; and
at least one crosspiece that rigidly connects said at least two trays;
wherein said roller unit is designed to retrofit a cargo carrying surface with a conveyor system.

17. A device of claim 16, wherein said cargo carrying surface is one of the floor of an ISO cargo container and the top surface of a portable platform, including a Flatrack and a CROP.

18. A device of claim 16, wherein said at least one roller is cylindrically shaped and has a composition that comprises aluminum.

19. A method of loading cargo onto a generally flat cargo carrying surface comprising:
attaching a roller unit adjacent to a generally flat cargo carrying surface, said roller unit comprising:
at least two trays for mounting rollers;
at least one roller for supporting cargo mounted in each of said at least two trays, said rollers designed to allow translation of the cargo supported thereby via a rolling motion; and
at least one crosspiece that rigidly connects said at least two trays;
wherein said roller unit is designed to retrofit a cargo carrying surface with a conveyor system; and
loading cargo onto said roller unit attached to said generally flat cargo carrying surface.

20. The method of claim 18, wherein the step of attaching is performed to allow said roller unit to be reversibly detached and reattached to said cargo carrying surface.
